(19) United States
(12) Patent Application Publication
(10) Pub. No.: US 2016/0294835 A1
(43) Pub. Date: Oct. 6, 2016

(54) Initiating a Secure Action Via Physical Manipulation

(71) Applicant: Lenovo (Singapore) Pte. Ltd., Singapore (SG)

(72) Inventors: Suzanne M. Beaumont, Wake Forest, NC (US); James A. Hunt, Chapel Hill, NC (US); Robert J. Kapinos, Durham, NC (US); Axel Ramirez Flores, Cary, NC (US); Rod D. Waltermann, Rougemont, NC (US)

(21) Appl. No.: 14/673,969

(22) Filed: Mar. 31, 2015

(51) Int. Cl. H04L 29/06

(52) U.S. Cl. CPC H04L 63/102; H04L 63/0876

(57) ABSTRACT

An approach is provided for sending a non-visual challenge request to a wearable device worn by a user. A non-visual challenge response is received from the wearable device, such as by the user moving the wearable device. The non-visual challenge response is compared to an expected response. The system allows usage of a resource by the user of the wearable device in response to the comparison revealing that the non-visual challenge response matches the expected response.

### BACKGROUND

Traditional security measures typically involve the user performing tasks to enter a security passcode or other security measure that might be easily be captured by a malicious hacker or individual. Malicious individuals are well aware of traditional approaches of entering passcodes and other security measures and often use keystroke capturing software or video cameras to capture such security information when provided by the rightful user. Often, the rightful user is unaware that they are being recorded, watched, or observed. Voice-input technology, where a user provides a vocal security measures, are also vulnerable because the malicious individual can over-hear or record the passcode spoken by the user.

### SUMMARY

An approach is provided for sending a non-visual challenge request to a wearable device worn by a user. A non-visual challenge response is received from the wearable device, such as by the user moving the wearable device. The non-visual challenge response is compared to an expected response. The system allows usage of a resource by the user of the wearable device in response to the comparison revealing that the non-visual challenge response matches the expected response.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram depicting interactions between the various components that are used to initiate a secure action using physical manipulation;

FIG. 4 is a flowchart showing steps taken by a setup process;

FIG. 5 is a flowchart showing steps taken to secure a system using a secure action that uses physical manipulations; and

FIG. 6 is a flowchart showing steps taken by a process that challenges a user that is using wearable technology to perform a security action.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. As used herein, a computer readable storage medium does not include a transitory signal.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

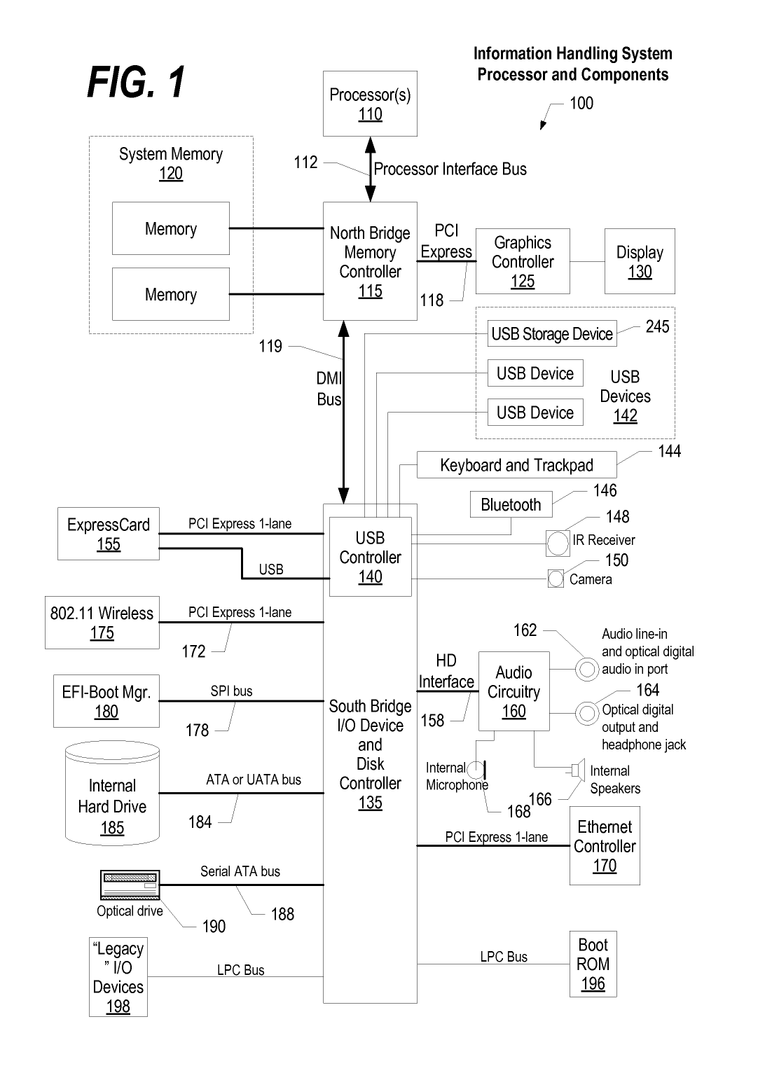

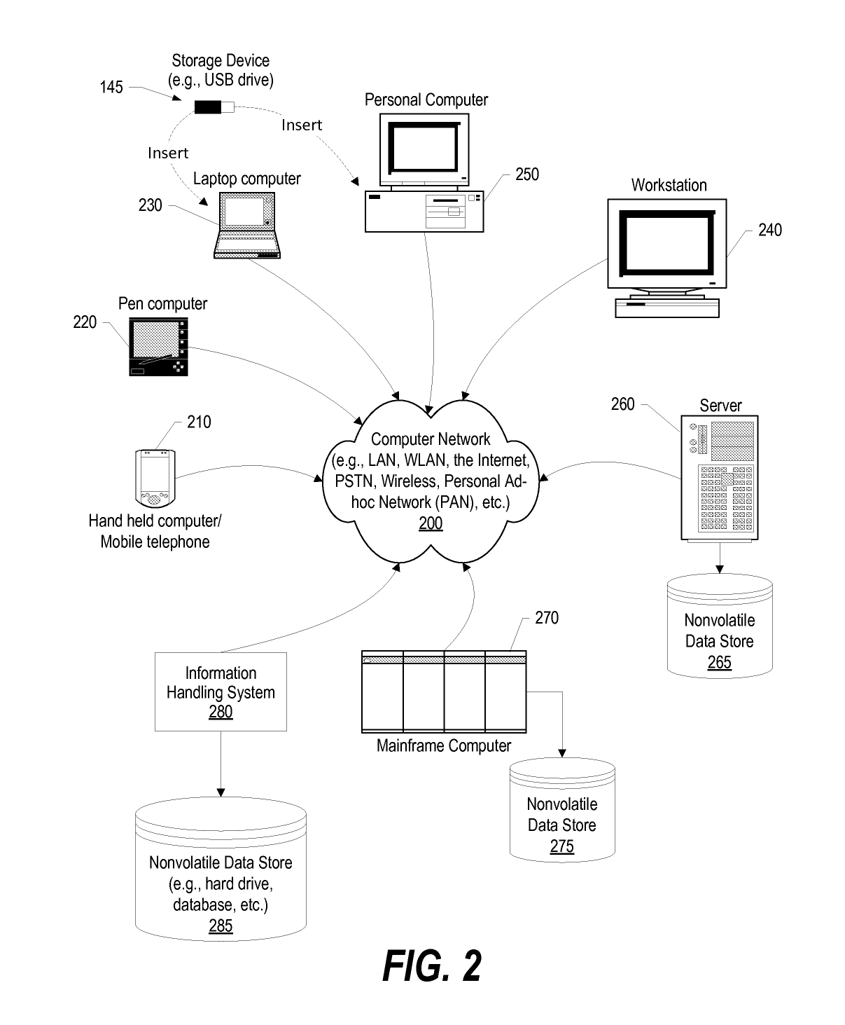

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

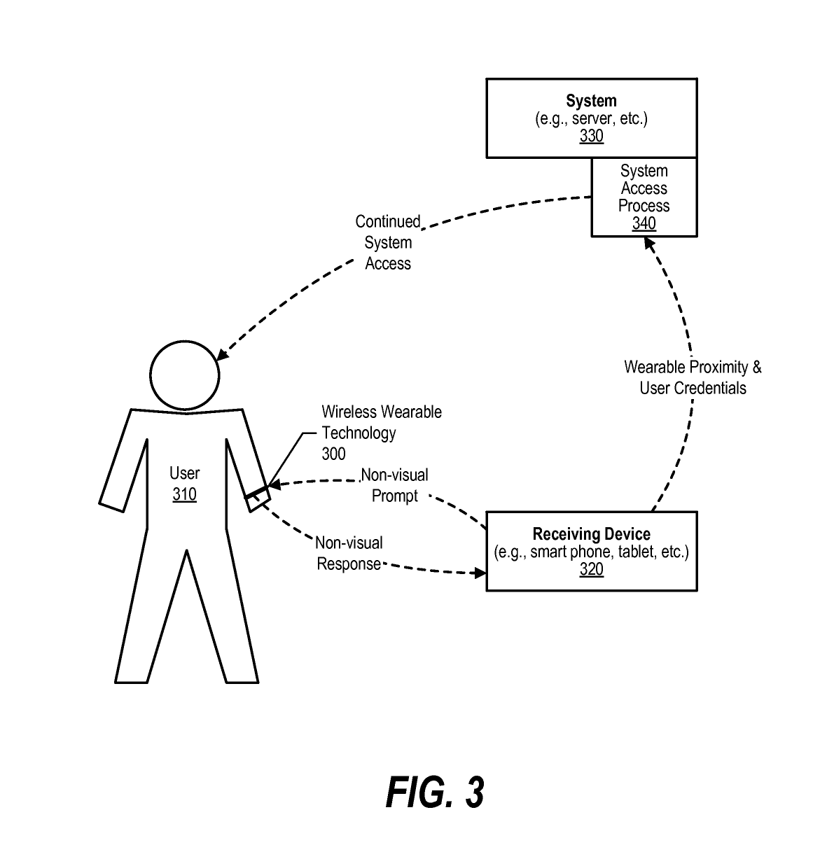

FIG. 3 is a component diagram depicting interactions between the various components that are used to initiate a secure action using physical manipulation. User 310 operates wearable device 300 that is wirelessly connected to system 330 either directly or through receiving device 320, such as a smart phone, slate or tablet computer system, traditional notebook or desktop computer system, and the like. The user provides a non-visual response using the wearable device and, when successfully provided, system 330 provides access to a controlled resource by utilizing system access process 340.

This approach uses wearable device to provide an alternative method for initiating a secure action so that the user can access a resource, such as a computer system. This approach is well suited for environments where spoken phrases could be overheard, keystrokes might be recorded, or where input methods are limited.

This approach proposes a handshake, or passcode, to be used between a user and the wearable device utilizing alternative user inputs. Diverse inputs specifically envisioned include touch, such as taps or swipes applied to the wearable device, or 2-D or 3-D gestures applied with the device, such as nods, claps, waves, head shakes/wags, fist pumps, etc. When an expected non-visual response is received from the user, access to a secured resource such as log-in to a system, access to a secured program, access to data, etc. is provided. This approach may involve the display or generation of a pattern that the user must mimic or respond responsively through touch or swipes or other 2-D gestures or 3-D gestures, or the imitation of a rhythmic dialog with agreed upon rhythmic phrase and answer.

An example would be the iconic “shave and a haircut” opening phrase displayed as a pulsating image in the appropriate 5 syllable rhythm with the expected answer of “two bits” delivered in the appropriate answering interval through two taps or swipes on the wearable device, or jabs or hand waves in the air, or any of the 2-D and 3-D gestures noted above, that are sensed by the wearable device. To again use a familiar rhythm, the wearable device could deliver a haptic version (vibration, squeeze) of “shave and a haircut”, with the user delivering the expected “two bits” response as either some sort of physical contact with the wearable (taps, squeezes, button actuations) or engaging the wearable as a whole by shaking it, re-orienting (rotating it), sliding it, flipping it, etc.

A final aspect of this approach is the ability to offer individualized challenges for which the response is known only to the user. This extension to the traditional concept of challenge and response security protocol into new user input domains and provides additional security of controlled resources. Responses delivered using the wearable device emphasize user input methods that are difficult, or impossible, to duplicate by others unfamiliar with the expected non-visual responses, thus decreasing the likelihood that the user input could be spoofed or hacked.

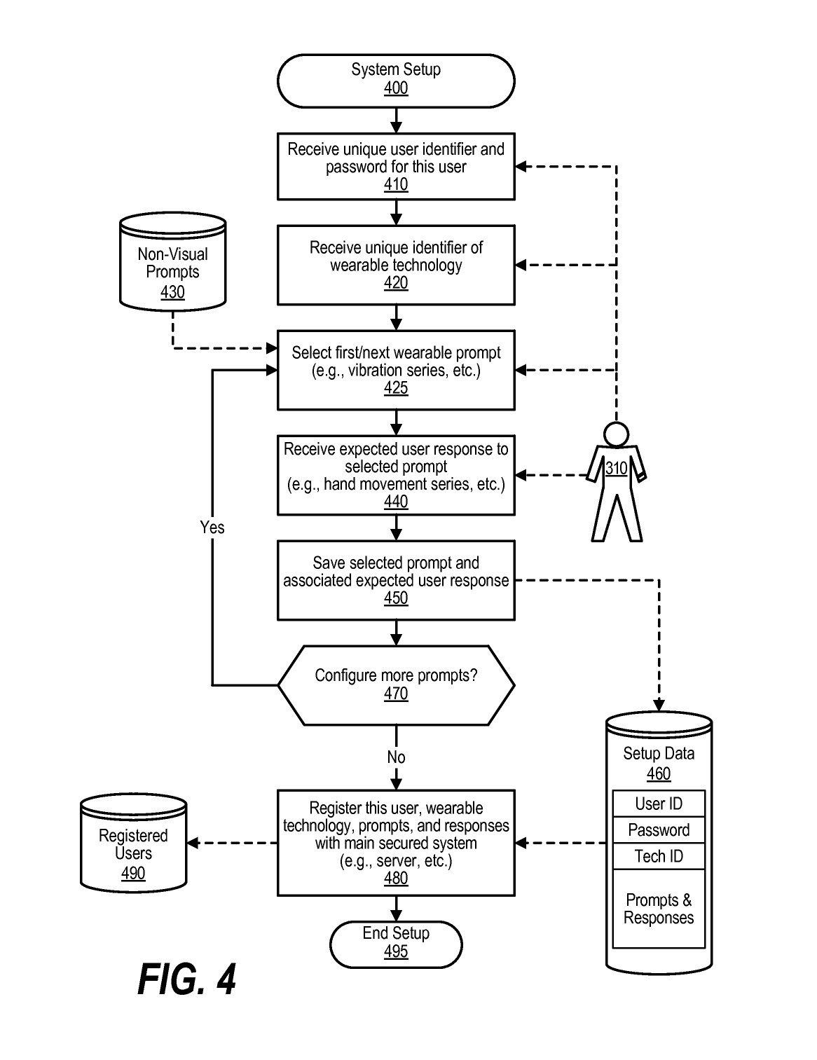

FIG. 4 is a flowchart showing steps taken by a setup process. FIG. 4 commences at 400 and shows the steps taken by a process that performs system setup, or configuration, steps to enable non-visual challenge responses from a user. At step 410, the process receives a unique user identifier and a password to associate with this user. At step 420, the process receives a unique identifier, such as a serial number or media access control address (MAC address), associated with the wearable device.

At step 425, the process selects the first non-visual prompt (e.g., vibration series, etc.). The non-visual prompt is used to form a non-visual challenge request when the system is in operation to control access to a resource. In one embodiment, a list of available non-visual challenge prompts is retrieved from data store 430 and displayed to user 310 with the user selecting the non-visual challenge prompt. At step 440, the process receives the expected response that is to be associated with the non-visual challenge request selected in step 425 (e.g., hand movement series, etc.). At step 450, the process saves the selected non-visual challenge prompt (request) and the associated expected non-visual challenge response that corresponds to the prompt. The non-visual challenge request and its associated expected response are saved in setup data store 460 along with the user's unique identifier, password, and the identifier associated with the wearable device.

The process determines as to whether the user wishes to configure additional non-visual challenge request and associated expected responses (decision 470). If the user wishes to configure additional non-visual challenge request and associated expected responses, then decision 470 branches to the ‘yes’ branch which loops back to receive the next non-visual challenge request and its associated expected response as described above. This looping continues until the user does not wish to configure additional non-visual challenge request and associated expected responses, at which point decision 470 branches to the ‘no’ branch to complete the setup process.

At step 480, the process registers user 310, the wearable device used by the user, the non-visual challenge requests and the associated expected responses with the main secured system (e.g., server, etc.). This data is stored in registered user data store 490 that is used by the secured system to select non-visual challenge requests, receive non-visual challenge responses from the user, and determine if the expected response was received from the user in order to control access to a controlled resource. Setup processing shown in FIG. 4 thereafter ends at 495.

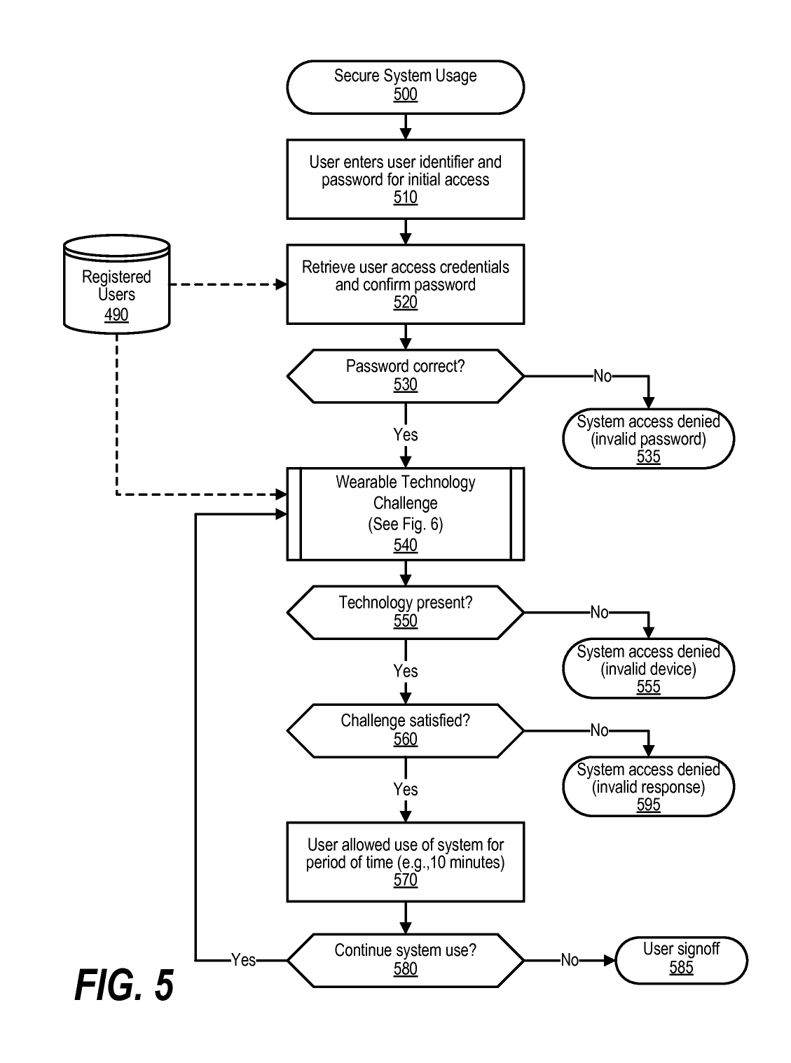

FIG. 5 is a flowchart showing steps taken to secure a system using a secure action that uses physical manipulations. FIG. 5 commences at 500 and shows the steps taken by a process that secures usage of a resource, such as a system, by utilizing a wearable device worn by a user. At step 510, in one embodiment, the user enters the assigned user identifier and password for initial access to the resource. If an initial user identifier and password are not being used, the process can commence at predefined process 540 and skip steps 510 through 535.

At step 520, the process retrieves the user access credentials from data store 490 and confirms the password entered by the user. The process determines as to whether the password entered by the user is the correct password (decision 530). If the password entered by the user is the correct password, then decision 530 branches to the ‘yes’ branch for further processing. On the other hand, if the password entered by the user is incorrect, then decision 530 branches to the ‘no’ branch whereupon, at 535, the process ends with the system denying access to the user.

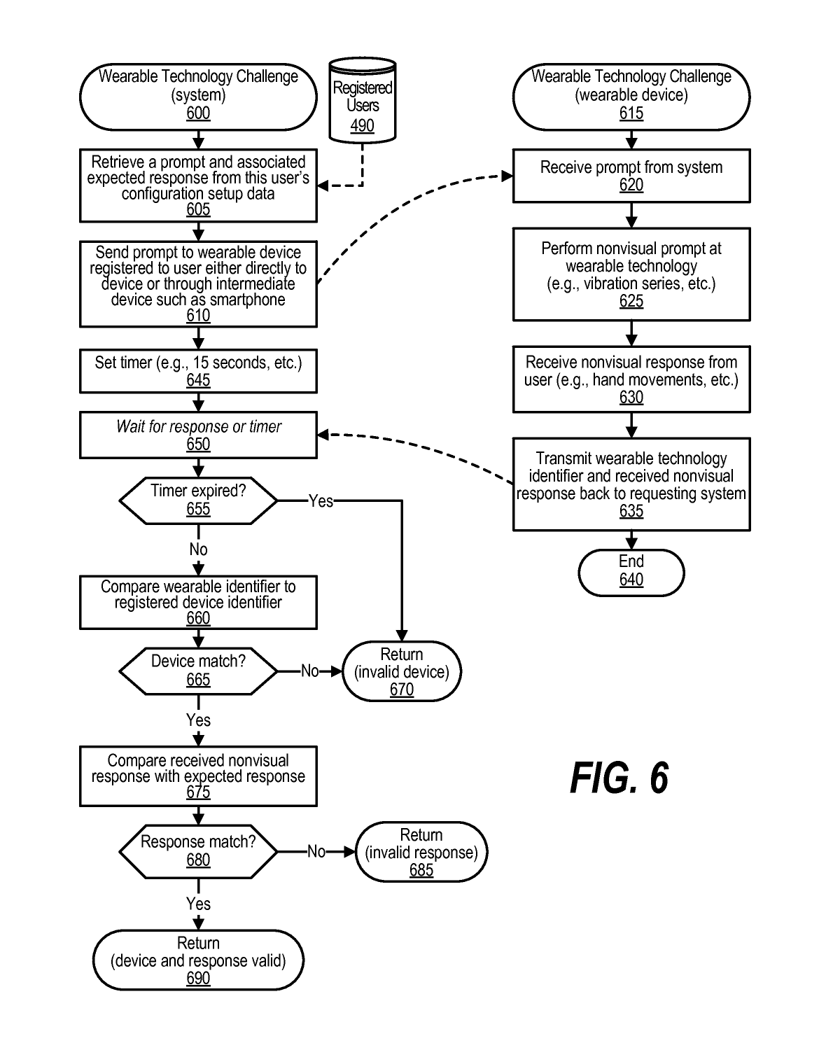

At predefined process 540, the process performs the Wearable Technology Challenge routine (see FIG. 6 and corresponding text for processing details). During predefined process 540, the user is presented with a non-visual challenge request at the user's wearable device and provides a non-visual response that is compared to an expected response to allow the user continued access to the resource, such as access to a computer system. The process determines as to whether the registered wearable device was found to be present with the user (decision 550). If the registered wearable device was found to be present with the user, then decision 550 branches to the ‘yes’ branch for further processing. On the other hand, the registered wearable device was not found to be present with the user, then decision 550 branches to the ‘no’ branch whereupon, at 555, the process ends with access to the resource being denied because the user does not have the valid, or registered, wireless device needed to access the system.

The process determines as to whether the non-visual challenge was successfully satisfied by the user's use of the wearable device (decision 560). If the non-visual challenge was successfully satisfied by the user's use of the wearable device, then decision 560 branches to the ‘yes’ branch for further processing. On the other hand, if the non-visual challenge was not successfully satisfied by the user's use of the wearable device, then decision 560 branches to the ‘no’ branch whereupon processing ends at 595 with access to the resource being denied because the user did not provide the expected non-visual response when prompted.

At step 570, the process allows the user use of the controlled resource, such as a computer system, for period of time (e.g., ten minutes, one hour, etc.). The amount of time to allow use before re-challenging the user may be dependent on the sensitivity or value of the resource being utilized by the user. The process determines as to whether the user continues to utilize the controlled resource after the time allowed in step 570 has expired (decision 580). If the user continues to utilize the controlled resource, then decision 580 branches to the ‘yes’ branch which loops back to predefined process 540 to send a non-visual challenge request to the user's wearable device and receive the non-visual challenge response from the user. This looping continues until the user signs off or otherwise stops utilizing the controlled resource, at which point decision 580 branches to the ‘no’ branch and processing ends at 585.

FIG. 6 is a flowchart showing steps taken by a process that challenges a user that is using wearable technology to perform a security action. FIG. 6 commences at 600 and shows the steps taken by the system that controls access to a resource from a user that is wearing a wearable device. At step 605, the process retrieves a non-visual challenge request and its associated expected response from this user's setup data that is retrieved from data store 490. At step 610, the process sends the non-visual challenge request to the wearable device registered to the user with the either directly to the device or through an intermediate device such as a smartphone, tablet, slate, or other computer system.

The steps taken by the user wearing the wearable device commence at 615. At step 620, the wearable device worn by the user receives the non-visual challenge request, such as a series of vibrations. At step 625, the process performs the non-visual challenge request at the user's wearable device. For example, the non-visual challenge request might be a series of vibrations emitted to the user through the device. At step 630, a non-visual challenge response is received at the wearable device from the user that is wearing the device. For example, in response to receiving the vibration series, the user might respond by performing a hand gesture that moves the wearable device in a particular, and expected, manner. At step 635, the process transmits the user's wearable device identifier (e.g., serial number, MAC address, etc.) and the non-visual challenge response received from the user. The identifier and challenge responses are transmitted back to requesting system (e.g., wirelessly either directly or via an intermediate device such as a smart phone or other computer system, etc.). Processing performed by the user utilizing the wearable device thereafter ends at 640.

Returning to the processing performed at the access control system, at step 645, after sending the non-visual challenge request to the wearable device worn by the user, the process sets timer (e.g., 15 seconds, etc.). This sets the amount of time that the user has to complete the non-visual challenge response and transmit it back to the access control system. At step 650, the process waits for either a response to be received from the wearable device worn by the user or for the timer to expire. The process determines as to whether the timer expired before receiving the non-visual challenge response from the user (decision 655). If the timer expired, then decision 655 branches to the ‘yes’ branch whereupon processing returns to the calling routine (see FIG. 5) at 670 with a return code indicating that a response was not received from a valid device. On the other hand, if the timer did not expire, then decision 655 branches to the ‘no’ branch for further processing.

At step 660, the process compares the wearable device identifier returned with the response from the wearable device to the device identifier registered with the system and stored in data store 490. In one embodiment, ensuring that responses are received from registered wearable devices provides an additional layer of security and makes it more difficult for hackers or other malevolent users to gain access to the controlled resource. The process determines as to whether the identifier of the wearable device matches the identifier registered with the system (decision 665). If the identifier of the wearable device matches the identifier registered with the system, then decision 665 branches to the ‘yes’ branch for further processing. On the other hand, if the identifier of the wearable device matches the identifier registered with the system, then decision 665 branches to the ‘no’ branch whereupon processing returns to the calling routine (see FIG. 5) at 670 with a return code indicating that the response was received from an invalid, or unregistered, device.

At step 675, the process compares the received non-visual challenge response with the expected response retrieved from data store 490. The process determines as to whether the non-visual challenge response received from the wearable device worn by the user matches the expected response (decision 680). If the non-visual challenge response received from the wearable device worn by the user matches the expected response, then decision 680 branches to the ‘yes’ branch whereupon processing returns to the calling routine (see FIG. 5) at 690 with a return code indicating that the wearable device is a valid device and that the non-visual challenge response received from the user successfully matched the expected response. On the other hand, if the non-visual challenge response received from the wearable device worn by the user fails to match the expected response, then decision 680 branches to the ‘no’ branch whereupon processing returns to the calling routine (see FIG. 5) at 685 with a return code indicating that the non-visual challenge response received from the user did not match the expected response.

While particular embodiments have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to others containing only one such element, even when the same claim includes the introductory phrases “one or more” or “at least one” and indefinite articles such as “a” or “an”; the same holds true for the use in the claims of definite articles.

1. A method comprising:
sending a non-visual challenge request to a wearable device, wherein the request is a pattern of one or more vibrations that the wearable device creates that are felt by a user of the wearable device, wherein the pattern is selected from a plurality of available patterns with each pattern corresponding to a different one of a plurality of expected responses with the selected pattern corresponding to a selected expected response from the plurality of expected responses;
receiving a non-visual challenge response from the wearable device based on a movement detected at the wearable device;
comparing the non-visual challenge response to the selected expected response; and
allowing usage of a resource by the user of the wearable device in response to the comparison revealing that the non-visual challenge response matches the selected expected response.

2. The method of claim 1 further comprising:
receiving a wearable-device identifier from the wearable device;
comparing the wearable-device identifier with a registered wearable-device identifier; and
inhibiting usage of the resource in response to the wearable-device identifier failing to match the registered wearable device identifier.

3. The method of claim 1 further comprising:
setting a timer in conjunction with the sending of the non-visual challenge request; and
inhibiting usage of the resource in response to the timer expiring before the reception of the non-visual challenge response.

4. (canceled)

5. The method of claim 1 wherein the non-visual challenge response is a pattern of one or more movements of the wearable device by the user.

6. The method of claim 1 further comprising:
prior to sending the non-visual challenge request:
selecting the non-visual challenge request from a plurality of non-visual challenge requests;
receiving the expected response to the selected non-visual challenge request from the wearable device, wherein the expected response is a result of movement of the wearable device by the user; and
associating the non-visual challenge request with the expected response.

7. The method of claim 6 further comprising:
prior to sending the non-visual challenge request:
receiving a wearable device identifier corresponding to the wearable device; and
associating the received wearable device identifier with the user.

8. An information handling system comprising:
one or more processors;
a memory coupled to at least one of the processors;
a communications adapter that sends and receives communications to and from wearable devices; and
a set of instructions stored in the memory and executed by at least one of the processors to:
send a non-visual challenge request to a wearable device, wherein the request is a pattern of one or more vibrations that the wearable device creates that are felt by a user of the wearable device, wherein the pattern is selected from a plurality of available patterns with each pattern corresponding to a different one of a plurality of expected responses with the selected pattern corresponding to a selected expected response from the plurality of expected responses;
receive a non-visual challenge response from the wearable device based on a movement detected at the wearable device;
compare the non-visual challenge response to the selected expected response; and
allow usage of a resource by the user of the wearable device in response to the comparison revealing that the non-visual challenge response matches the selected expected response.

9. The information handling system of claim 8 wherein the set of instructions further comprise further instructions executed by at least one of the processors to:
receive a wearable-device identifier from the wearable device;
compare the wearable-device identifier with a registered wearable-device identifier; and
inhibit usage of the resource in response to the wearable-device identifier failing to match the registered wearable device identifier.

10. The information handling system of claim 8 wherein the set of instructions further comprise further instructions executed by at least one of the processors to:
set a timer in conjunction with the sending of the non-visual challenge request; and
inhibit usage of the resource in response to the timer expiring before the reception of the non-visual challenge response.

11. (canceled)

12. The information handling system of claim 8 wherein the non-visual challenge response is a pattern of one or more movements of the wearable device by the user.

13. The information handling system of claim 8 wherein the set of instructions further comprise further instructions executed by at least one of the processors to:
prior to the send of the non-visual challenge request:
select the non-visual challenge request from a plurality of non-visual challenge requests;
receive the expected response to the selected non-visual challenge request from the wearable device, wherein the expected response is a result of movement of the wearable device by the user; and
associate the non-visual challenge request with the expected response.

14. The information handling system of claim 13 wherein the set of instructions further comprise further instructions executed by at least one of the processors to:
prior to the send of the non-visual challenge request:
receive a wearable device identifier corresponding to the wearable device; and
associate the received wearable device identifier with the user.

15. A computer program product comprising:
a computer readable storage medium comprising a set of computer instructions, the computer instructions effective to:
send a non-visual challenge request to a wearable device, wherein the request is a pattern of one or more vibrations that the wearable device creates that are felt by a user of the wearable device, wherein the pattern is selected from a plurality of available patterns with each pattern corresponding to a different one of a plurality of expected responses with the selected pattern corresponding to a selected expected response from the plurality of expected responses;
receive a non-visual challenge response from the wearable device based on a movement detected at the wearable device;
compare the non-visual challenge response to the selected expected response; and
allow usage of a resource by the user of the wearable device in response to the comparison revealing that the non-visual challenge response matches the selected expected response.

16. The computer program product of claim 15 wherein the set of instructions further comprise instructions effective to:
receive a wearable-device identifier from the wearable device;
compare the wearable-device identifier with a registered wearable-device identifier; and
inhibit usage of the resource in response to the wearable-device identifier failing to match the registered wearable device identifier.

17. The computer program product of claim 15 wherein the set of instructions further comprise instructions effective to:
set a timer in conjunction with the sending of the non-visual challenge request; and
inhibit usage of the resource in response to the timer expiring before the reception of the non-visual challenge response.

18. (canceled)

19. The computer program product of claim 15 wherein the non-visual challenge response is a pattern of one or more movements of the wearable device by the user.

20. The computer program product of claim 15 wherein the set of instructions further comprise instructions effective to:
prior to the send of the non-visual challenge request:
receive a wearable device identifier corresponding to the wearable device;
associate the received wearable device identifier with the user;
select the non-visual challenge request from a plurality of non-visual challenge requests;
receive the expected response to the selected non-visual challenge request from the wearable device, wherein the expected response is a result of movement of the wearable device by the user; and
associate the non-visual challenge request with the expected response.
